(19) United States
(12) Patent Application Publication
(10) Pub. No.: US 2026/0119944 A1
(43) Pub. Date: Apr. 30, 2026

(54) METHOD AND SYSTEM FOR ONGOING TEMPORAL FEEDBACK AND CONTROL DURING QUANTUM KEY DISTRIBUTION USING DATA ANALYSIS

(71) Applicant: Quantized Technologies Inc., Calgary (CA)

(72) Inventors: Jordan Daniel SMITH, Calgary (CA); Daniel OBLAK, Calgary (CA); Anuj SETHIA, Calgary (CA); Hanen CHENINI, Calgary (CA); Ashutosh SINGH, Calgary (CA); Itzel LUCIO MARTINEZ, Calgary (CA)

(21) Appl. No.: 19/104,974

(22) PCT Filed: Jul. 20, 2024
(86) PCT No.: PCT/IB2024/000369

§ 371 Date: Feb. 19, 2025

Related U.S. Application Data
(60) Provisional application No. 63/527,960, filed on Jul. 20, 2023.

(51) Int. Cl. G06N 10/40

(52) U.S. Cl. CPC G06N 10/40

(57) ABSTRACT

A quantum communication system and associated methods are described for securely establishing a cryptographic key between multiple transmitters and a receiver. Each transmitter emits qubit signals from a light source within defined time windows, characterized by specific bases and modes controlled by a transmitter controller. The receiver utilizes an interference device with multiple inputs to receive qubit signals and outputs to generate an interference signal, which is detected by multiple detectors. A receiver controller sends information on detected outputs to transmitters and provides feedback based on temporal characteristics. Simultaneously, the system adjusts subsequent qubit signal characteristics based on this temporal feedback, enabling the establishment of a cryptographic key between transmitters using the detected signals. This adjustment optimizes the cryptographic key rate, enhancing security and efficiency in quantum communication protocols.

### A) TECHNICAL FIELD

The present invention is generally related to the field of quantum key distribution. The present invention is particularly related to temporal feedback and control during quantum key distribution. The present invention is more particularly related to Method and System for Ongoing Temporal Feedback and Control during Quantum Key Distribution Using Data Analysis.

### B) BACKGROUND OF THE INVENTION

Quantum key distribution (QKD) is a secure communication technique that employs a cryptographic protocol rooted in quantum mechanics principles. This method facilitates the generation of a shared, random secret key between two parties, ensuring that the key remains exclusively known to them. The secret key can subsequently be utilized for the encryption and decryption of messages, providing robust secure communication.

Many quantum technologies utilize quantum photonic interference, which mandates that input qubit signals be indistinguishable across one or more degrees of freedom at the interference device (e.g. temporal indistinguishability). Achieving and maintaining the indistinguishability of two light pulses across these parameters presents a significant technical challenge in generation and manipulation of qubit signals.

Lo, H-K et al. (“Measurement-Device-Independent Quantum Key Distribution” PRL 108, 130503 (2012)) discloses a measurement-device-independent quantum key distribution (QKD) system which removes all detector side channels and doubles the secure distance with conventional lasers.

Berrevoets, R. C., et al. (“Deployed measurement-device independent quantum key distribution and Bell-state measurements coexisting with standard internet data and networking equipment.” Commun Phys 5, 186 (2022)) discloses a Measurement-Device Independent Quantum Key Distribution (MDI-QKD) system, containing a Bell-State measurement node, over the same fiber connection as multiple standard Internet Protocol (IP) data networks, between three nearby cities in the Netherlands. Over 10 Gb/s of classical data communication rates simultaneously with the MDI-QKD system was demonstrated, and 200 GB/s of classical data transmission was predicted to be achievable without significantly affecting QKD performance.

Tang, Y-L et al. (“Measurement-Device-Independent Quantum Key Distribution over Untrustful Metropolitan Network” Phys. Rev. X, 6, 011024 (2016)) discloses measurement-device-independent quantum key distribution (MDIQKD) network in a star topology over a 200-square-kilometer metropolitan area, which is secure against untrustful relays and against detection attacks. In the field test, the system continuously ran through one week with a secure key rate 10 times larger than previous results.

The above-mentioned shortcomings, disadvantages and problems are addressed herein, and which will be understood by reading and studying the following specification.

### C) OBJECTS OF THE INVENTION

The primary object of the present invention is to provide quantum communication systems specifically to feedback systems and methods that ensure the maintenance of qubit signal indistinguishability at the receivers during the key distribution process.

Another object of the present invention is to provide a quantum communication system including multiple transmitters and a receiver. Each transmitter emits qubit signals within specific time windows, corresponding to various bases and modes.

Yet another object of the present invention is to provide receiver features an interference device with multiple inputs to receive qubit signals and outputs to generate an interference signal.

These and other objects and advantages of the embodiments herein will become readily apparent from the following detailed description taken in conjunction with the accompanying drawings.

### D) SUMMARY OF THE INVENTION

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The present disclosure pertains to quantum communication systems specifically to feedback systems and methods that ensure the maintenance of qubit signal indistinguishability at the receivers during the key distribution process.

Aspects and features disclosed herein are described in detail below. Unless otherwise specified, any disclosed aspects and features may be combined or used independently.

Provided in accordance with aspects of the present disclosure is a quantum communication system including multiple transmitters and a receiver. Each transmitter emits qubit signals within specific time windows, corresponding to various bases and modes. A transmitter controller regulates these signals. The receiver features an interference device with multiple inputs to receive qubit signals and outputs to generate an interference signal. Multiple detectors detect this signal. A receiver controller transmits detected output signal information to transmitters and provides temporal feedback. The system adjusts subsequent qubit signals based on this feedback, involving temporal characteristics. Moreover, the system uses transmitted information from detected outputs to establish at least part of a cryptographic key between transmitters concurrently.

The feedback enables subsequent qubit signals to be adjusted to maximize cryptographic key rate and qubit signals may be adjusted while the cryptographic key is getting established. Feedback from the receiver is based on temporal information determined from a temporal analysis of a plurality of the detected output signals.

A single detected output signal may serve dual purposes: contributing to the establishment of at least part of the cryptographic key and providing temporal information for feedback to adjust characteristic of subsequently transmitted qubit signals. Adjusting temporal characteristic aims to enhance the indistinguishability of qubit signals fed into the interference device. Improved indistinguishability can potentially increase the rate of cryptographic key, or cipher, generation within the system.

The modes within each basis are orthogonal, meaning that no single mode within a basis can be constructed using a linear combination of other modes within the same basis. Additionally, each mode within one basis can be expressed as a linear combination of multiple modes from the other basis.

A qubit or quantum bit is a basic unit of quantum information. A qubit has two distinct states (e.g., one representing “0” and one representing “1”). Unlike a classical bit, a quantum bit can also exist in superposition states, be subjected to incompatible measurements, and/or be entangled with other quantum bits. In the context of this present disclosure, the term “qubit” encompasses two-state qubits, as well as qudits, denoting a unit of quantum information that can be realized in suitable d-level quantum systems (e.g., a three-level “qutrit”).

The system may be configured to make subsequent adjustments to the transmitted qubit signals based on the most recently received feedback and based on previous adjustments and associated feedback.

The receiver controller may be configured to generate a binned distribution of detected arrival times for qubit signals, and wherein the temporal feedback is based on the width of the generated binned distribution. Each bin in the binned distribution has a temporal width of less than 80 ps.

The qubit signals may be optical signals. A qubit signal may comprise a single photon. The qubit signals may be generally transmitted from the transmitter to the receiver via a fiber optic cable. The qubit signals may also be transmitted from the transmitter to the receiver wirelessly.

A characteristic of a qubit signal may be adjusted based on the feedback by the transmitter. E.g., based on temporal feedback, the transmitter may change the timing of the generation of a qubit signal.

At least one of the transmitter and receiver controllers may comprise a Field-Programmable Gate Array. At least one of the transmitter and receiver controllers may comprise a GPU (graphics processing unit) and/or a CPU (central processing unit). At least one of the transmitter and receiver controllers may comprise one or more integrated circuit (IC) microprocessors. At least one of the transmitter and receiver controllers may comprise memory configured to store computer program code.

The feedback is provided for an aggregated period, which consists of a predetermined number of qubit signals received (e.g., at least 30 qubit signals). This predetermined number is based on achieving a certain level of statistical significance.

The aggregated period for temporal feedback characteristics can be the same or different. It is determined by a minimum number of output signals needed to calculate the relevant temporal statistics. The aggregated period also includes a predetermined time frame. Further, a single output signal can be used both to generate the cryptographic key and provide feedback to adjust temporal characteristics.

Because each output signal is a result of multiple qubits signals coming together at the interference device, the temporal information may be calculated based on a plurality of temporally spaced apart output signals received over a period of time. Moreover, a single output signal may be used both to generate the cryptographic key and provide feedback to adjust temporal characteristics. In addition, a single output signal may be used as part of separate temporal analyses for feedback for parameters.

If a characteristic tends to unstable, the system may be configured to perform temporal analysis on the output signals more frequently to generate feedback for that characteristic. Additionally, the number of output signals required to conduct a meaningful temporal analysis is another important factor. If the temporal analysis requires simply a rate of any type of output signal, measuring over a short period of time may provide temporal based meaningful results. However, if only a subset of the total output signals is being used, then the system may be configured to monitor these temporal states over a longer period of time to ensure that a temporal meaningful result can be obtained.

The cryptographic key may be established based on information relating to detected output signals corresponding to suitable entangled basis states. In the case of two transmitters, the suitable entangled basis states may be Bell states. In the case of more than two transmitters, the suitable entangled basis states may be Greenberger-Horne-Zeilinger (GHZ) states.

The cryptographic key may be established based on information relating to detected output signals corresponding to a photon in an early time bin detected at a first detector and a photon in a late time bin detected at a second detector.

Each qubit signal of the transmitted qubit signals may be encoded using early and late time bins within the time window. Each qubit signal of the transmitted qubit signals is encoded using temporal degree of freedom.

In another aspect of the present disclosure, there is provided a quantum communication system receiver comprising: an interference device having multiple inputs configured to receive multiple series of qubit signals from multiple transmitters and multiple outputs configured to produce signals based on the interference of the received qubit signals at the interference device; multiple detectors configured to detect the output signals at the multiple outputs of the interference device; and a receiver controller configured to transmit information relating to the detected output signals to the transmitters, and to provide feedback based on the outputs, wherein the feedback comprises temporal information on a plurality of the detected output signals and corresponds to the following temporal characteristic of the qubit signals.

In another aspect of the present disclosure, there is provided a method for establishing at least a portion of a cryptographic key, the method comprising: transmitting a series of qubit signals from multiple transmitters, each qubit signal being within a respective time window and corresponding to a basis within a plurality of bases and a mode within a plurality of modes of the basis; and controlling the series of qubit signals emitted by a light source; receiving the qubit signals at a receiver; interfering multiple qubit signals from the multiple transmitters to produce an interference output signal based on interference at the interference device; detecting the output signal at multiple outputs; and transmitting information relating to the detected output signals to the transmitters, automatically providing feedback based on a temporal analysis of the detected output signals over a period of time, wherein the feedback corresponds to temporal characteristics of the qubit signals, wherein the characteristics comprising temporal similarity of the qubit signals, and concurrently enabling adjustment of subsequently transmitted qubit signals based on the received feedback and establishing at least part of a cryptographic key between the transmitters based on the transmitted information relating to the detected output signals. The method comprises adjusting temporal characteristics of subsequently transmitted qubit signals based on the received feedback.

In yet another aspect of the present disclosure, a single photon detector may comprise one or more of the following: a photomultiplier tube (PMC), a hybrid photodetector (HPM), a single-photon avalanche diode, and a superconducting nanowire single-photon detector (SNSPD).

In still yet another aspect of the present disclosure, Quantum key distribution (QKD) is a secure communication method employing a cryptographic protocol based on quantum mechanics. It allows two or more parties to generate a shared secret key known only to them, which can be used to encrypt and decrypt messages. The key may consist of an ordered string of bits or characters. To ensure a key is considered secure, it must meet two criteria:

It must be correct, meaning the key bit strings held by the multiple transmitters must be identical.

It must be verifiably secret, ensuring the key bit string is known only to the multiple transmitters and not to any third party.

The output signals utilized to establish at least a portion of the cryptographic key may also contribute to the temporal information used to provide feedback for adjusting temporal characteristics of subsequently transmitted qubit signals.

In another aspect of the present disclosure, when emitted from the transmitter, a signal that is ultimately utilized for establishing the cryptographic key may be identical (e.g., in terms of temporal) to a signal that is ultimately utilized for providing feedback to the transmitter. The utilization of the signal may be determined by various factors, including one or more of: the signal transmitted concurrently within the same time window by other transmitters, the manner in which the signal traverses through the interference device, and the basis selected by each of the transmitters.

The output signals utilized for establishing at least part of the cryptographic key may additionally contribute to the temporal information employed to adjust characteristics of subsequently transmitted qubit signals.

In another aspect of the present disclosure, qubit signals may incorporate decoy states. Practical QKD systems utilize multi-photon sources, deviating from the ideal BB84 protocol, thereby rendering them vulnerable to photon number splitting (PNS) attacks. Addressing this inherent vulnerability of practical QKD systems involves employing a decoy state technique, wherein multiple intensity levels are used at the transmitter's source. For instance, a transmitter transmits qubits using varying intensity levels (one signal state and several decoy states), each exhibiting diverse photon number throughout the channel. Post-transmission, the transmitter publicly discloses which intensity level was employed for transmitting each qubit.

Each qubit signal in the series of qubit signals may have the same or approximately the same intensity (e.g., within ±10% of a mean average). Some embodiments may use a decoy state protocol specifying different intensities for different intensity categories. In these embodiments, each qubit signal within the same intensity category may have the same or approximately the same intensity (e.g., within a predetermined range, such as ±10%, of a mean average). Each qubit signal within the series of qubit signals possesses an approximately identical temporal profile. The ultimate use of the signal may be influenced by various factors, including: the signals transmitted within the same time window by other transmitters, the path the signal takes through the interference device, and the basis selected by each transmitter.

In yet another aspect of the present disclosure, the light source may comprise one or more of: a laser, a single molecule, an ion, a Rydberg atom, a diamond color center, a defect center within a lattice, a spontaneous-parametric-down-conversion source, a spontaneous four-wave mixing source, and a quantum dot.

In still yet another aspect of the present disclosure, the cryptographic key can be established exclusively using information derived from detected outputs, where one photon is detected in an early time bin at a first detector, and another photon is detected in a late time bin at a different second detector.

In still yet another aspect of the present disclosure, an interference device may comprise a single beam splitter. An interference device may comprise multiple beam splitters. An interference device may consist of passive or active optical components.

In still yet another aspect of the present disclosure, the system employs a calibration phase where robust signals containing multiple photons are transmitted from the transmitters to the receiver. This phase aims to establish initial conditions for tuning the timing of the transmitters, thereby ensuring the reception of indistinguishable photons at the interference device.

In still yet another aspect of the present disclosure, the temporal analysis is beneficial due to the dependence of specific outputs on quantum states, which inherently yield random outcomes upon measurement (e.g., originating from qubit signal generation or interference at the device). Consequently, identical setups of multiple systems would typically yield differing outputs. However, over time, the temporal analysis should yield a sufficiently consistent set of results to enable meaningful feedback generation.

In another aspect of the present disclosure, the detection rate of a specific output signal may involve measuring the time required to reach a predefined count of detected signals, and/or tallying the number of detected signals within a set time interval. Essentially, this rate reflects the frequency of detections over a specified timeframe.

The transmitter controller may comprise an FPGA. The transmitter controller may comprise a microcontroller. A microcontroller may also comprise a single circuit (IC) chip. A controller may comprise one or more processor cores along with memory and programmable input/output peripherals.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### E) BRIEF DESCRIPTION OF THE DRAWINGS

The other objects, features and advantages will occur to those skilled in the art from the following description of the preferred embodiment and the accompanying drawings in which:

In the detailed description section below, one or more embodiments of the present technology are described in relation to the attached figures. These embodiments are intended to provide a better understanding of the invention, how the invention may be put into practice, and to demonstrate some of the advantages of the invention. The drawings are not necessarily to scale, emphasis instead being placed upon illustrating the principles of various embodiments of the invention. Various aspects and features of the present disclosure are described hereinbelow with reference to the drawings wherein like numerals designate similar elements in each of the several views and:

FIG. 1a is a schematic overview of an embodiment of a quantum communication system

FIG. 1b is a graph of the qubit signals generated by the transmitters.

FIG. 2 is a block diagram of timing system

FIG. 2a is a pulse temporal overlap as measured by the FP

FIG. 3 Method of Establishing a Cryptographic key

Although the specific features of the present invention are shown in some drawings and not in others. This is done for convenience only as each feature may be combined with any or all of the other features in accordance with the present invention.

### F) DETAILED DESCRIPTION OF THE DRAWINGS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

As previously noted, various techniques have been proposed for utilizing quantum mechanics to establish a shared key between multiple users. The application of quantum mechanics enables the two communicating users to ascertain whether a third party is attempting to obtain information about the key (e.g., through eavesdropping).

In the category of quantum communication systems described herein, two users transmit qubits to a central receiver where the qubits can interact with each other via an interference device. It is crucial that the qubits are sufficiently indistinguishable to facilitate the establishment of a key.

Historically, various methods have been employed to ensure that qubits are indistinguishable. These methods include:

Utilizing a calibration mode where strong laser pulses are sent by the transmitters without any decoy or qubit modulation and scanning the wavelength, as detailed in the background section.

Cryptographic key, in both cases, the light sources are adjusted using additional modes (e.g., spatially, using auxiliary fiber, or temporally, using separate time intervals) separate from those in which quantum signals are distributed to ensure that the spectrum of the light source, the frequency, timing and polarization of the light from each of the sources match. Then the light source is switched to a qubit mode (with a modulated lower intensity), and this is used to transmit qubit signals to establish or distribute the cryptographic key.

Further, quantum key distribution can be enhanced by reducing or eliminating drift in the light sources during the distribution process. Although the light sources may initially emit sufficiently indistinguishable qubit pulses, however temporal profile of the qubit signals may be undesired. This drift reduces the degree of indistinguishability, leading to a decrease in the key generation rate and potentially resulting in a shorter key being established over a given time period, which can be problematic if a minimum key length is required.

A method has been devised for continuously monitoring the degree of indistinguishability during key distribution and providing feedback to allow real-time adjustments to the qubit signals, ensuring that any drift or perturbation in the transmitters and/or quantum transmission lines can be effectively compensated.

The disclosed invention pertains to a system wherein the receiver autonomously provides feedback based on detected outputs to facilitate adjustments in the transmitted signals, thereby enhancing their indistinguishability. This feedback pertains specifically to the temporal similarity of the qubit signals.

The system is configured to automatically adjust the transmitted qubit signals based on the received feedback in real time; and establish a cryptographic key between the transmitters based on the outputs signals.

Various aspects of the invention are described with reference to the figures. For illustrative purposes, the components depicted in the figures are not necessarily drawn to scale; rather, emphasis is placed on highlighting the contributions of the components to the functionality of the invention. Throughout the description, several alternative features are introduced. It should be understood that, according to the knowledge and judgment of a person of ordinary skill in the art, these alternative features may be substituted in various combinations to achieve different embodiments of the invention.

### Quantum Communication System

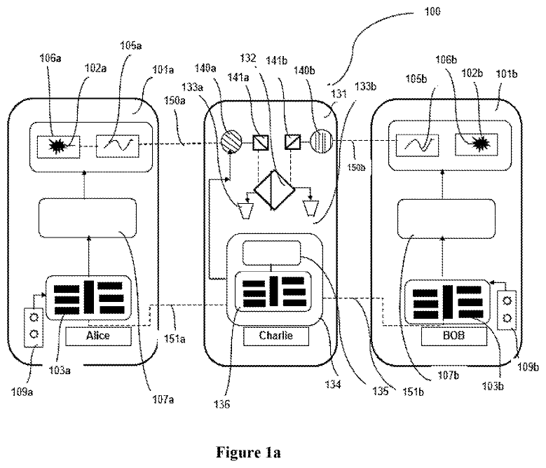

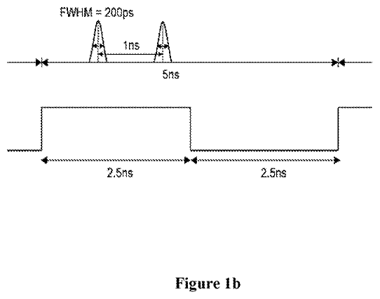

Referring to FIG. 1a, FIG. 1a illustrates the structure of quantum communication system.

FIG. 1a shows a quantum communication system 100 comprising at least two transmitters 101a, b and a receiver 131. As is customary in the field, the transmitters (or users) are named Alice (101a) and Bob (101b) and it is these devices that are trying to establish, transmit or distribute a common cryptographic key. The receiver is named Charlie (131).

In quantum key distribution, Eve typically represents a third-party entity attempting to intercept the generated key without detection by the transmitters (and possibly the receiver). Transmitters (101a, 101b) are generally assumed to be trustworthy, while the trustworthiness of the receiver, Charlie (131), remains uncertain. In the context of MDI-QKD (Measurement-Device-Independent QKD), Eve possesses full knowledge of the central node's operation, measurement outcomes, and hardware access. Consequently, MDI-QKD does not differentiate between Charlie and Eve at the central node, treating the central node itself as untrustworthy due to Eve's potential capabilities and access.

Each transmitter (101a, 101b) includes: a light source (106a, 106b) designed to emit a series of qubit signals, where each qubit signal consists of one or more quantum pulses arranged in time bins and within a specified time window; and a transmitter controllers (103a, 103b) configured to manage the emission of the series of qubit signals from the light source.

The qubit signals are transmitted through a quantum channel using fiber optic cables (150a, 150b). These cables can vary in length, for instance, up to 200 km, and may be laid out in diverse configurations. Alternatively, in some scenarios, qubit signals can be transmitted through free space, such as when Charlie (131) is positioned on a satellite or communicating wirelessly with the transmitters.

The receiver includes an interference device (132) with multiple inputs designed to receive the series of qubit signals, and it features multiple outputs that generate an output signal based on the interference occurring within the device. Additionally, there are multiple detectors (133a,133b) within the receiver (131) configured to detect the output signal at the various outputs of the interference device.

The receiver also includes a receiver controller (134) designed to analyze the output signals detected by the detectors (133a,133b) and to autonomously provide feedback based on these detected signals. The feedback pertains to timing of qubit signals. Information regarding the output signals can be conveyed back to the transmitters (101a, 101b) through a classical communication channel, which may utilize fiber optic cables (151a,151b) in certain embodiments. Alternatively, in other configurations, communication may occur through free-space channels. In some embodiments, parts of the feedback information may also be transmitted through a classical network, such as the Internet, which may or may not involve the use of fiber optic or free-space channels.

In this case, each qubit signal corresponds to one of a plurality of bases and to a mode within that basis.

In FIG. 1b, the qubits are encoded in time-bins. Time-bin encoding of qubits involves creating pulses in any combination of two time-bin modes; the early mode, represented by the state |e [symbol] , and the late mode, represented by the state |l [symbol] . For a single pulse, the two time-bin modes form the Z-basis {|e [symbol] ,|l [symbol] }, and the coherent superposition of the two time-bin modes forms the X-basis {|e [symbol] ±|l [symbol] }.

The time-bin modes can be encoded by generating a pulse from a source (e.g., a laser) that is suppressed by an intensity modulator everywhere in the temporal domain except in the desired time bins. The X-basis states, |± [symbol] =(1/\sqrt{2}) (|e [symbol] ±l [symbol] ) are prepared by inducing a relative phase of θ={0, π} between the early and late time-bin modes using a phase modulator. Decoding is accomplished simply by using single-photon detectors with jitter that is less than the time separation between the early and late bins.

Further, FIG. 1b shows the laser operation at a clock rate of 200 MHz (cycle period=5 ns). Early and late time-bins are 200 ps wide and are separated by 1 ns. In this embodiment, the early and late time bins are arranged in a 2.5 ns time window in which the laser is above threshold (e.g., within the generated pulse).

As with phase encoding, preparing time-bin qubits involves more complexity, but the advantage is that decoherence is largely mitigated when using optical fiber as the quantum channel, as long as the time bins are within the coherence time of the pulse.

### Quantum Key Distribution Protocol

An MDI-QKD protocol is illustrated as below in Table 1 and proceeds as follows:

Alice and Bob agree on what each state represents in the computational basis (e.g., let |e [symbol] ,|+ [symbol] =0 and |l [symbol] ,|− [symbol] =1). Both Alice and Bob prepare phase-randomized WCPs (Weak Coherent Pulse) in the four possible states—here time-bin encoding is used—and send them over public channels to an untrusted relay, Charlie (or Eve).

TABLE 1
a. Illustration of the MDI-QKD protocol

| | | | | | | |
|---|---|---|---|---|---|---|
| Alice basis | Z | X | Z | X | X | Z |
| Alice bit | 1 | 0 | 0 | 1 | 1 | 1 |
| Alice state | \|l [symbol] | \|+ [symbol] | \|e [symbol] | \|− [symbol] | \|− [symbol] | \|l [symbol] |
| Bob basis | X | X | Z | Z | X | Z |
| Bob bit | 1 | 1 | 1 | 0 | 1 | 0 |
| Bob state | \|− [symbol] | \|− [symbol] | \|l [symbol] | \|e [symbol] | \|− [symbol] | \|e [symbol] |
| Charlie/Eve BSM | \|Ψ⁻ [symbol] | \|Ψ⁻ [symbol] | None | None | \|Ψ⁺ [symbol] | \|Ψ⁺ [symbol] |
| Same basis? | No | Yes | Yes | No | Yes | Yes |
| Alice sifted key | | 0 | | | 1 | 1 |
| Bob sifted key | | 1 | | | 1 | 0 |
| Sifted key | | 0 | | | 1 | 1 |
| QBER ≤ 11%? | | | Yes | | | |

The untrusted relay, Charlie, performs a Bell-state measurement (BSM) that projects the incoming signals onto a Bell state. Such a projective measurement can be accomplished using only linear optical elements. In this case, projections are restricted to |Ψ± [symbol] . Projection onto one or more Bell states allows a successful security proof.

Alice and Bob apply decoy-state techniques to estimate the yield and quantum bit error rate (QBER) for various input photon numbers.

Charlie announces over a public channel, which events result in a successful BSM, along with the results of the measurement (in cases where more than one Bell-state is used in the protocol).

Alice and Bob keep the data corresponding to their qubits that resulted in a successful BSM and discard the rest. They also communicate their basis choices via a public channel to post-select the events in which they used the same qubit-preparation basis.

Alice and Bob account for how the system responds to establish a common cryptographic key. In this embodiment, except for the events in which both Alice and Bob prepare qubits in the X-basis and Charlie successfully measures the |Ψ+ [symbol] Bell-state, the remaining key bits belonging to Alice and Bob are anti-correlated and require either Alice or Bob to apply a bit-flip to their data.

Typically, the final step in the process is that the common cryptographic key is then classically post-processed to remove any errors in the keys possessed by Alice and Bob, and to remove any information that Eve may have obtained about the mutual key shared by Alice and Bob.

Regarding the Bell states, the protocol utilizes quantum interference of photons from separate sources and a projective Bell-state measurement (BSM), resulting in an entangled-state measurement only when the photons are annihilated upon detection. The Bell basis includes the maximally entangled states:

$$\vert {Φ}^{\pm } = \frac{1}{\sqrt{2}} ( \vert {e}_{1} {e}_{2} \pm \vert {l}_{1} {l}_{2} )$$

$$\vert {Ψ}^{\pm } = \frac{1}{\sqrt{2}} ( \vert {e}_{1} {l}_{2} \pm \vert {l}_{1} {e}_{2} )$$

After passing through the beam splitter, the measured outputs at outputs 3 and 4 correspond to the following:

$$\vert {Ψ}^{+} {\to }^{BS} \frac{i}{\sqrt{2}} ( \vert {e}_{3} {l}_{3} + \vert {e}_{4} {l}_{4} )$$

$$\vert {Ψ}^{-} {\to }^{BS} \frac{1}{\sqrt{2}} ( \vert {e}_{3} {l}_{4} - \vert {l}_{3} {e}_{4} )$$

$$\vert {Φ}^{+} {\to }^{BS} \frac{i}{2} ( \vert {e}_{3} {e}_{3} + \vert {e}_{4} {e}_{4} + \vert {l}_{3} {l}_{3} + \vert {l}_{4} {l}_{4} )$$

$$\vert {Φ}^{-} {\to }^{BS} \frac{i}{2} ( \vert {e}_{3} {e}_{3} + \vert {e}_{4} {e}_{4} - \vert {l}_{3} {l}_{3} - \vert {l}_{4} {l}_{4} )$$

Not all of the possible input states from Alice and Bob undergo quantum interference at the receiver's beam splitter, such as input Z-basis states |e [symbol] and |l [symbol] . Given that the wavefunctions of these two states have no temporal overlap, they do not interfere in a beam splitter and can, therefore, be considered orthogonal states in Hilbert space. Whether the input states from Alice and Bob are orthogonal or not in degree of freedom in which the qubit signals are encoded, they must still be indistinguishable in all other degrees of freedom for a Bell-state projection to be possible.

This constraint is due to the requirement for no possible ‘which-path’ information that could correspond to correlations between photon detections and their sources.

The Bell-state measurement is the foundation of the “measurement-device-independent” property of MDI-QKD, since measurement results are not one-to-one with prepared qubits. Rather, prepared qubits are two-to-one with measurement results, as Alice and Bob each prepare a qubit for every Bell-state measurement result. The consequence is that each measurement result does not announce information about a specific monopartite quantum state of a photon, which could reveal information about the key to a third party, such as Eve, but rather it announces a correlation relation between the two qubits prepared by Alice and Bob corresponding to the specific Bell-state measurement event. Finally, this means that even if Eve has full information about the measurement results, at best she knows only about the correlation between the qubits sent by Alice and Bob, and knows nothing about the final bit string that becomes their secure key.

After sifting the raw key, Bob applies a bit-flip to his sifted key except where both Alice and Bob prepared a qubit in the X-basis and the BSM resulted in a |Ψ+ [symbol] projection. After using decoy-state techniques to estimate QBER, if the value is ≤11% the secure key is kept and error correction and privacy amplification are applied, otherwise the key is discarded, and the protocol is repeated.

Although a complete network may support a star-type topology, a first embodiment, as illustrated in FIG. 1a, includes just two end users, Alice and Bob, and a central node, Charlie.

Qubit generation is accomplished according to a decoy-state protocol and is controlled using random bits from quantum random number generators (QRNGs) by field-programmable gate array (FPGA) units. The decoy-state protocol and the optical isolators at the end users are useful to prevent side-channel attacks on the photon sources operated by the end users.

System parameters, such as channel loss and propagation delay, are estimated before key-exchange commences, so that WCP attenuation can be adjusted to optimize the various levels of the decoy-state protocol and each end user can correlate their received BSM (Bell State Measurement) signals with their transmitted qubits. After key exchange, classical post-processing (error correction and privacy amplification) of the data is done via automated processes performed by the FPGAs at the end-users (transmitters). The quantum and classical signals will be compatible with classical telecommunications signals sent over the same fibers by means of dense wavelength division multiplexing (DWDM) to mitigate the noise effects of Raman scattering.

Qubits are sent from Alice and Bob to Charlie for Bell-state measurement. Photon detection is achieved at Charlie using a single photon detector. Time-reversed entanglement is created by passing indistinguishable WCPs from Alice and Bob through a beam splitter interference device and detecting them via single photon detectors, where bipartite detection (e.g., detection of photons at two separate detectors) enables a BSM projection onto the |Ψ− [symbol] state. In this embodiment, only the |Ψ− [symbol] state is used for key distribution. Other embodiments may use other multipartite entangled states (e.g., GHZ states or multiple Bell states) for key distribution.

The central node at Charlie includes a synchronizing clock signal, as well as feedback-based control systems to ensure that the end users produce qubits that are indistinguishable in the temporal degrees of freedom as they arrive at and are overlapped on Charlie's beam-splitter.

It will be appreciated that, in quantum mechanics, the indistinguishability of two photons is a continuous variable. That is, it is theoretically possible to have completely distinguishable or indistinguishable photons, but in practical terms, it is possible to have completely distinguishable photons, completely indistinguishable photons, and partially indistinguishable photons. Indistinguishable photons are those which are sufficiently indistinguishable such that they interact with each other at the interference device to a sufficient degree to permit a cryptographic key to be established. That is, indistinguishable photons may include partially indistinguishable photons.

One challenge in producing indistinguishable photons lies in the uncertainty associated with the temporal characteristics of time-bin pulses.

### Alice and Bob Transmitters

Alice and Bob transmitter devices 101a and 101b have an identical structure. The hardware architecture located at Alice and Bob (101a and 101b) contains all components and control systems necessary to generate qubits and send them to Charlie (131) through a quantum channel. As the experimental setup belonging to Alice and that belonging to Bob are identical, only one will be described in the following.

Alice and Bob (101a and 101b) may have the same hardware architecture, but one transmitter (e.g., Alice) may have additional code to allow her to receive feedback from Charlie (131) to adjust the output of her laser to match its wavelength with that of Bob's laser.

The light source 106a,106b in this embodiment comprises: a laser (102a,102b) which is a semiconductor-type laser, and various optical components 105a,105b used to modulate and convert the raw laser pulse into a qubit signal. The laser operates at a single wavelength (e.g., of ˜1550 nm).

Changing the temperature of the cavity, using a temperature controller, causes expansion or contraction of laser cavity length, and a subsequent change in the index of refraction. Consequently, the optical path length of the cavity changes, allowing for tuning of the central wavelength as needed to match the wavelengths emitted by Alice and Bob (101a and 101b). The light source is controlled by a transmitter controller, which in this case uses an FPGA (103a,103b). The transmitter controller (103a,103b) controls the laser driver (which provides a stable current supply for the laser diode), and the temperature controller.

Generally, the laser should have a linewidth of below a predetermined threshold value (e.g., 2 MHz). The predetermined threshold linewidth value may be configured to meet a certain threshold percentage of erroneous BSM detections. These thresholds may be determined according to the need for generating a key (e.g., key length, rate of key generation etc.). The laser may have a power of less than 40 mW. The laser may be tunable such that the central wavelength can be controlled within less than a nanometer.

Regarding the transmitter controller 103a,103b, the FPGA 103a, 103b is an integrated circuit with an array of programmable logic blocks that perform logical computations at the hardware level, rather than using software for computation. An advantage of using arrays of logic blocks is that they are much faster than soft microprocessors in some applications, due to their parallel nature and optimality in the use of logic gates. Commercial FPGA architectures often integrate micro-processing systems and related peripherals that can be used as a complete “system on a programmable chip”.

The FPGAs in the design act as the hardware-control and data-processing units for the system, with an FPGA unit located at each transmitter (and the receiver). The FPGAs at the locations of Alice and Bob have an identical function in terms of qubit state preparation. At Alice and Bob (101a, 101b), the FPGA takes random bits of data as input from an external QRNG 109a,109b (Quantum Random Number Generator) and then translates that data into a particular state to be prepared for each qubit. The FPGA then sends output signals to each hardware component in the state-preparation setup, resulting in qubits being prepared and sent to Charlie (131). In this embodiment, these transmitted qubits are initially used to estimate the channel loss and propagation delay of the system, after which they are used to perform the MDI-QKD protocol. In other embodiments, higher power classical intensities could also be used to perform calibration. The specific input and output signals from Alice's FPGA will be discussed along with the different peripherals that send (receive) signals to (from) the FPGA.

FPGAs of Alice and Bob have similar or identical functions with the exception of 1. taking different feedback signals and using them to control indistinguishability characteristics, e.g., laser wavelength. 2. In the post-processing step, either Alice or Bob (101a, 101b) may send asymmetric information to the other to inform an action to ensure that their secure keys are identical and private.

The respective propagation times between Alice and Charlie, 150a and Bob and Charlie, 150b may vary with time (e.g., due to thermal fluctuations in the optical fiber links 150a,150b). In this embodiment, a temporal feedback-based control system is employed to compensate for such variations in qubit arrival times to ensure temporal indistinguishability between the received qubits sent from Alice and Bob. At Charlie, the receiver controller analyses the timing of the single photon detector (superconducting nanowire single photon detector) detections to assess the temporal overlap of the pulses arriving from Alice and Bob. If pulses corresponding to the respective time-bins arrive slightly earlier or later from Bob than those from Alice, this will be manifested as a temporal broadening of the detection events, assuming the FPGA and single photon detectors have sufficient temporal resolution. As Charlie distributes the master clock to both Alice and Bob, in this embodiment, the FPGA adjusts the phase of the master clock signal sent to Alice or Bob in order to match the arrival time of Alice's and Bob's qubits at Charlie, maximizing the overlap of the corresponding detection events. From previous experiments using deployed fibers, the timing drift may be in the range of 0-10 ps per minute, depending on the fiber link, which is sufficiently small to enable the acquisition of pulse-timing data with adequate statistical significance to compensate for the drift.

As Charlie distributes the master clock to both Alice and Bob, the FPGA in this embodiment adjusts the phase of the master clock signal sent to Bob to match the arrival time of Alice's and Bob's qubits at Charlie. Based on previous experiments using deployed fibers, the timing drift may range from 0 to 10 ps per minute, depending on the fiber link. This drift is sufficiently small to enable the acquisition of pulse-timing data with adequate statistical significance to compensate for the drift. As a result of slow thermal drifts in the lasers 102a,b used by Alice and Bob for qubit signal preparation, the wavelengths of the lasers vary slowly with respect to one another.

For the controllers 103a,b of the transmitters and of the receiver to accomplish the tasks described above, they require certain capabilities: sufficient clock rate to process data and output the necessarily fast electrical signals to peripheral devices, sufficient memory to store the data used to generate the secure key, sufficient input/output (I/O) ports to interface with all necessary peripherals, a sufficient number of processors to multi-task, and a sufficient number of programmable logic (PL) cells to perform simultaneous logic operations. Generally, the transmitter and/or receiver controllers should have a clock rate of at least 400 MHz.

Further, the light source is controlled by the transmitter controller via electrical conditioning components 107a, 107b. As noted above the light source comprises: a laser 106a and optical conditioning components 105a, 105b for converting the raw light signal into a qubit signal.

The optical conditioning components in this case may comprise one or more of: an intensity modulator, a phase modulator, a pulse modulator, an attenuator, a beam splitter, and an isolator. The electrical conditioning components may comprise one or more of: a digital to analog converter (fast and or slow); an analog to digital converter; a RF amplifier and a DC amplifier.

The general purpose of an intensity modulator is to create the optical pulses encoding the time-bin states based on the electrical signals from the transmitter controller 103a,103b. The electro-optic intensity modulator takes an optical signal from the laser with a time-varying electrical signal as inputs, and it produces a time-varying optical signal as output. Specifically, in the task of qubit preparation in this embodiment, the purpose of the first intensity modulator is to take a 2.5 ns pulse from the laser as input, and to suppress that pulse entirely (or at least sufficiently, e.g., by a factor of 100, or to at least 30 dB).

In this embodiment, the working principle of the intensity modulator is that of a phase-modulated Mach-Zehnder interferometer (MZI), in which an electro-optic intensity modulator takes an incoming optical signal and splits it into two arms via a beam splitter. It also takes an electrical input signal to produce an electric potential difference in one arm across the wave-guide medium (LiNbO3 in this case) changing its temporal-dependent index of refraction, an effect referred to as the Pockels effect. The result is a relative change in the optical path-length between the two arms, producing a phase shift in the signal traversing the first arm relative to the signal in the second arm. The optical signals from the two arms are recombined using another beam splitter, at which they interfere. The result is that, by applying the appropriate voltage to the IM, there is constructive interference at the output port when an optical signal is desired, and complete destructive interference, corresponding to a relative π-shift in the phase-modulated arm, or Δφ=mπ for odd m, when an optical signal is not desired. In other embodiments, other types of intensity modulators may be used.

For the present design, the intensity modulator must meet specific criteria: it needs sufficient bandwidth to swiftly modulate and generate distinct time-bin signals. Additionally, the extinction ratio (ER), which denotes the ratio of complete constructive to complete destructive interference, must be sufficiently high. This ensures excellent contrast and a high signal-to-noise ratio (SNR). Maintaining a high ER is crucial because any failure to fully suppress laser pulses outside of the desired time-bins can lead to erroneous detections at Charlie, thereby increasing the Quantum Bit Error Rate (QBER)

Generally, the intensity modulator should have a bandwidth of at least 10 GHz and span the frequency range of the light source. The extinction ratio of the intensity modulators should be greater than 30 dB for DC signals and greater than 20 dB for radio frequency (RF) signals.

Separate intensity modulators may serve different functions. For instance, a first intensity modulator could create time-bin states by modulating the intensity of input laser pulses overtime. Meanwhile, a second intensity modulator might adjust the overall intensity within a clock cycle to implement varying intensities required by the decoy-state protocol. The vacuum state could be generated by completely suppressing the optical signal using both intensity modulators in series. Additionally, the relative intensities of the signal and decoy states could be controlled using the second intensity modulator.

The phase modulator (PM) is designed to take an optical signal and an electrical input signal to induce a shift in optical path length, thereby producing a phase-shifted optical output signal. Similar to the electro-optic intensity modulator (IM), the electro-optic PM utilizes the Pockels effect to achieve this phase shift. In the experimental setup, the specific role of the phase modulator is to introduce a π-phase shift in the late time-bin when preparing the state. The waveguide medium employed in this instance is LiNbO3.

The performance requirements of the phase modulator are similar to those of the intensity modulator, with some exceptions. Specifically, the required bandwidth of the phase modulator is less than half that of the intensity modulator, as it only needs to modulate the optical phase of the late time-bin and not the early one. Unlike the intensity modulator, there is no requirement for extinction ratio (ER) in the phase modulator since it does not involve optical interference. Additionally, there is no DC-bias voltage applied to the phase modulator. Control of the phase modulator is managed by the transmitter controller 103a,103b through electrical conditioning components. Generally, the phase modulator should have a bandwidth of at least 5 GHz.

Additionally, it is crucial that there be no information allowing Eve to distinguish between the prepared states. Therefore, the mean optical power of laser pulses used to prepare both Z-basis and X-basis states must be identical. The X-basis states, which consist of two pulses, achieve this by ensuring that each time-bin in X-basis states has half the intensity of the time-bins prepared in Z-basis states.

To ensure random state generation as required by the MDI-QKD protocol, a source of true random numbers is essential. A Quantum Random Number Generator (QRNG) 109a,109b relies on non-deterministic quantum measurement results to produce random bits of data. QRNGs typically provide specifications such as an entropy data rate and a post-processed data rate. The entropy data rate represents raw data resulting from measurements using imperfect hardware and non-uniform probability distributions. To remove biases from this data, various post-processing methods are employed, often resulting in the discarding of some bits to achieve unbiased, uniformly distributed random data. Consequently, the post-processed data rate is generally lower than the entropy data rate, often by nearly an order of magnitude in commercial devices.

In this embodiment, Alice and Bob each require 1 Gbps of post-processed random data for random state preparation and decoy level selection. The QRNGs used in the architecture also include interface modules to communicate with FPGAs via Ethernet or other I/O ports.

After generating qubits using relatively high-intensity optical signals controlled by the transmitter controller, laser, and intensity and phase modulators, it is necessary to attenuate the signal intensity to ensure the mean photon number of the qubits, μ, is <1. This attenuation is achieved using a combination of manual and electronic variable optical attenuators (VOAs).

In this embodiment, variable optical attenuators function by transmitting a diverging optical signal, in free space, into a collimating lens. The proportion of the collimated beam that is displaced away from the coupler into the outgoing fiber determines the level of attenuation.

The VOAs should be designed to operate effectively at 1550 nm wavelength and offer variable attenuation capabilities up to 70 dB. The setup includes VOAs with a combined attenuation range of 3-75 dB.

To mitigate source-targeting adversarial attacks, such as laser-seeding and Trojan Horse attacks, an optical isolator (ISO) is employed to enable one-way propagation of optical signals from Alice/Bob (101a, b) to Charlie (131). In this embodiment, the optical isolators, also known as Faraday isolators, utilize magneto-optic principles involving birefringence and rotation. They transmit light in the forward direction while absorbing or deflecting light traveling in the reverse direction.

Some source-targeting adversarial attacks, including the laser-seeding attack and Trojan Horse attack, allow Eve to obtain information about the assumed-to-be-secure key. To prevent such source attacks, an optical isolator (ISO) is used to allow optical signal propagation in one direction only, the outgoing direction from Alice/Bob (101a. 101b) to Charlie (131). In this embodiment, the optical isolators (also referred to as Faraday isolators) are magneto-optic devices that use the principles of birefringence to transmit light in the forward direction, while absorbing or displacing light propagating in the reverse direction.

The isolator in the experimental design should ensure low-loss propagation of outgoing 1550 nm light while providing at least 50 dB of isolation for incoming light.

In this embodiment, the transmitter receives feedback from Charlie via a fiber optic channel 151a. The received optical signal is converted to an electrical signal via a dense wavelength-division multiplexing (DWDM) small form-factor pluggable (SFP) transceiver. In the transmitter, the transceiver takes as input a multiplexed optical signal, i.e., a superposition of different wavelengths, and demultiplex it into its component wavelengths. It then converts the optical signals to electrical output signals which can be read by the transmitter FPGA 103a, 103b.

The requirements of the DWDM SFP are that it should have at least 3 channels to be capable of multiplexing/demultiplexing 3 separate signals, it should transmit/receive optical signal over at least 50 km of fiber, it should operate at a central wavelength of 1550 nm, and it should have a high enough bandwidth to process and send clock, measurement results, and feedback data from Charlie (131).

### Charlie (131) Receiver

The hardware setup at Charlie (131) includes electronic and photonic components essential for performing Bell State Measurements (BSMs), implementing synchronization control systems, and delivering measurement results, clock signals, and necessary feedback to Alice and Bob (101a, 101b).

The receiver controller 134, in this case comprising FPGA 136, resembles those found in Alice's and Bob's setups. At Charlie, the FPGA is synchronized with the master clock and receives input signals from logic board 135. This board provides Bell State Measurement (BSM) information based on signals from the single photon detectors 133a, 133b. Additionally, logic board 135 routes raw output signals from the single photon detectors directly to the FPGA without modification.

The projection into a Bell state can be achieved using single photon detectors, independent of the time-bin states prepared by Alice and Bob. Coincidence counts may occur when Alice and Bob prepare states with identical time bins but are distinguishable by other means. Temporal indistinguishability is facilitated by utilizing single-detection counts with the single photon detectors. With sufficient timing resolution, Charlie can utilize multiple single-detection samples to construct the average temporal pulse shape of single-count detections from signals transmitted by both Alice and Bob relative to the master clock signal. Charlie then adjusts the phase of the clock signal sent to Bob using a phase shifter to minimize the mean pulse width, thereby maximizing the temporal overlap of similar time-bin states from Alice and Bob.

The described functionality primarily necessitates three specifications for the single photon detectors: high detection efficiency, a sufficiently short dead time to register each qubit arrival, and excellent timing resolution, often referred to as timing jitter, to distinguish between states such as |e [symbol] and |l [symbol] with a high Signal-to-Noise Ratio (SNR). Ideally, a detection efficiency of 1 is preferred, but 0.9 is sufficient, particularly considering the current state of the art is approximately 0.95.

When considering the qubit preparation rate of 200 MHz, a straightforward requirement is that the dead time of single photon detectors should be less than 5 ns to ensure detection of all arriving qubits. This requirement is slightly relaxed when only |Ψ− [symbol] projections are used for establishing the cryptographic key, as only 25% of Bell State Measurements (BSMs) project onto the |Ψ− [symbol] state. Therefore, the average interval between |Ψ− [symbol] projections is expected to be around 20 ns, without accounting for other factors. In practice, realistic system parameters must be considered: qubit preparation rate of 200 MHz, mean photon number per laser pulse approximately 0.3 (including vacuum, decoy, and signal states), channel loss of 0.2 dB/km, insertion loss at Charlie around 5 dB, and detector efficiency of approximately 90%. Consequently, a single photon detector with a dead time of approximately 600 ns may be adequate to register, on average, all |Ψ− [symbol] projections.

The timing resolution of a single photon detector is characterized by the Full Width at Half Maximum (FWHM) of the temporal distribution of electrical output signals relative to photon arrival times. To accurately reconstruct the mean temporal pulse shape of single-detection counts, Nyquist-Shannon sampling theory indicates that the timing jitter of the single photon detectors should be less than half the temporal width of a single time-bin (200 ps), or ≤100 ps. Single photon detectors should typically exhibit an efficiency of at least 90%, a dead time of no more than 600 ns and a timing jitter of more or less than 100 ps.

The BSM component of the BSM/HOM board 135 converts the electrical single photon detector output signals corresponding to detection patterns that project onto the |Ψ− [symbol] Bell state, into an electrical Boolean output. The other Bell states are not used in this embodiment because the experimental design uses linear optics (a BS), no heralding or auxiliary photons, and non-photon-number-resolving single photon detectors with a dead time greater than the temporal separation between the early and late time-bins (1 ns). Using time-bin encoding, the various detection patterns are projected into the Bell basis described above. For a given qubit preparation event, when a |e [symbol] qubit is detected in one single photon detector and a |l [symbol] is detected in the other, the BSM board outputs an electrical signal corresponding to “True” to the central FPGA at Charlie, and a successful |Ψ− [symbol] measurement is recorded.

Due to the use of linear optics without auxiliary photons, as described earlier, this embodiment cannot unambiguously project onto the |Φ+ [symbol] and |Φ− [symbol] states based on detection patterns. Therefore, projection onto a single Bell state can only occur 50% of the time. If the detector's dead time were less than the separation between early and late time bins, it would also be possible to detect |Ψ− [symbol] Bell states, which could be utilized instead of or in addition to the |Ψ− [symbol] measurements.

The HOM component of the board detects the photon-bunching effect that occurs when indistinguishable photons arrive at the beam splitter of the interference device and are measured by photon detectors. When Alice and Bob (101a,101b) each prepare and send the same state to Charlie (131), the photons bunch together, resulting in an electrical signal detected by only one single photon detector. In contrast, when photons are distinguishable, no bunching occurs, and photons are randomly detected on separate detectors or the same detector. Consequently, the rate of coincidence counts using photons in the same time-bin decreases when photons are indistinguishable. This information can be utilized to provide feedback to any system component capable of altering distinguishability in a photonic degree of freedom, as demonstrated for temporal stabilization. In the system, timing stabilization is already managed by monitoring the detection-time distribution using low-jitter single photon detectors. Therefore, HOM interference is employed to ensure temporal alignment of the laser wavelengths. The board generates a Boolean ‘True’ output when signals are received from each single photon detector, and a coincidental electrical signal is produced by the detectors and sent to the BSM/HOM board.

In this embodiment, the receiver communicates with the transmitters via fiber optic cables 151a and 151b. To transmit signals to the transmitter, the receiver incorporates dense wavelength-division multiplexing (DWDM) small form-factor pluggable (SFP) transceivers. Each transceiver converts several electrical input signals into optical signals, multiplexes the various wavelengths corresponding to these inputs, and outputs the multiplexed optical signal.

The electronic components of the board must possess sufficient bandwidth to accurately replicate the temporal profile of the input signals, ensuring that timing uncertainty is not increased.

The master clock synchronizes qubit generation events and measurement results across Alice, Bob, and Charlie. Alice and Bob require a clock reference to correlate their qubit generation events with Bell State Measurement (BSM) results received from Charlie. Additionally, qubits generated by Alice and Bob must be temporally indistinguishable, necessitating synchronous arrival at Charlie.

Phase shifters are employed at the master clock source to compensate for varying propagation delay times between Charlie and Alice, and Charlie and Bob, ensuring the simultaneous arrival of qubits from both sources. The phase shifter can be a standalone device adjusting the clock signal or integrated directly into the FPGA through hardware or software modifications. The master clock does not require operation at 200 MHz or as an absolute clock. Serving as a relative clock with occasional reference pulses suffices for its purpose, provided these pulses are generated more frequently than the anticipated temporal drift.

The clock should, however, operate at a frequency that is a divisor of 200 MHz.

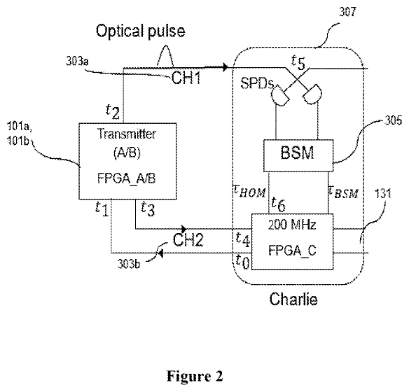

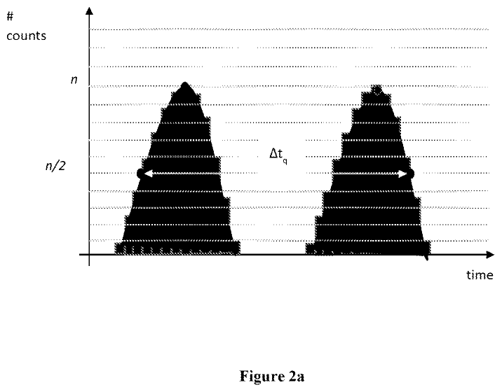

According to FIG. 2, the timing feedback system is enhanced to utilize HOM interference as a tool for assessing the synchronization of photons arriving at the interference device, complementing the detection event overlap maximization process mentioned previously. The HOM measurement is applicable across various mean photon numbers and bases, including Z and X. By introducing a photon pair into the interference device, we anticipate observing a HOM dip—a reduction in coincidence counts—as the arrival timing of the photons aligns. Optimal timing of photon arrival and emission occurs when the HOM dip is minimized. Timing feedback is based on a) time calibration, b) qubit overlap and c) overlap verification.

To perform a timing feedback and control protocol, the timing of the quantum channels is characterized, i.e. to quantify the time difference of transmission of the optical pulses emitted by Alice and Bob (101a, 101b) such that they arrive simultaneously at Charlie (131). In the timing feedback protocol, the following steps are required to ensure timing overlap between the optical pulses emitted by Alice and Bob at Charlie.

Initial timing synchronization protocol: the protocol is implemented to measure and then minimize the arrival time difference of qubit signals from Alice and Bob at Charlie.

To define:

$$Δ = \# of clock cycles$$

$${t}_{0} = trigger = {Cl}_{0} = 0 s$$

$$Δ {t}_{2} = {t}_{5} - {t}_{2}$$

$$Δ {t}_{4} = ( {t}_{4} - {t}_{0} ) / 2 = {Cl}_{1}$$

$$Δ {t}_{5} = {t}_{6} - {t}_{5}$$

$$Δ {t}_{6} = {t}_{6} - {t}_{0} = {Cl}_{2}$$

$${Δ}_{BSM - HOM} = {τ}_{BSM} - {τ}_{HOM}$$

Ch2 is a communication channel between Alice/Bob and Charlie. This channel may be implemented using, for example, optical fibers and SFP transceivers. For calibration:
1) Charlie sends a 200 MHz clock signal to Alice (101a) using Ch2(303)
2) Charlie sends trigger to Alice using Ch2 (303) at time t₀.
3) Alice (101a) receives trigger at time t₁ and sends high intensity pulses at a frequency between 1 KHz and 1 MHz via Ch1 at time t₂. Alice returns trigger at time t₃.
4) Charlie (131) detects an interference event (may be a HOM detection) at time t₆ and the return trigger from Alice at time t₄. Charlie adds Δ_{BSM-HOM} to Δt₅ and calculates Cl₁ and Cl₂. Charlie calculates Δt₂=Δt₆−Δt₅−Δt₄ to derive arrival time of the optical pulse at the interference device (t₅).
5) Charlie repeats this for at least 1 second or for longer duration if links are lossy and stops.
6) Charlie repeats process for Bob and calculates corresponding Δt₂ for Bob, derives t₅ for Bob.
7) Charlie (131) applies A offset to Alice (101a) or Bob (101b), such that t_{5A}=t_{5B}, where t_{5A} and t_{5B} correspond to the arrival times of the optical pulses from Alice and Bob and through the channels of Alice and Bob, respectively.

Further, transmitters Alice (101a) or Bob (101b) timing can be calculated as:

$$AFPGA \to tsignal - tsample = AFPGA tsignal - tsample$$

$$AFPGA \to tsignal - tsample = BFPGA tsignal - tsample$$

$$BFPGA \to tsignal - tsample = CFPGA tsignal - tsample$$

### For Qubit Overlap:

After the time calibration is done and the delay is applied, Alice's and Bob's optical pulses will be in the same clock cycle at the central node, Charlie.

Once the qubits are within a clock cycle, we do a search algorithm to overlap the qubits. A minimization algorithm is performed to reduce the time between the qubits Δtq (FIG. 2) that is being measured by the FPGA TDC and maximize BSM counts. In this mode, Charlie, the central node, delays Alice's or Bob's clock to optimize the qubit overlap. For overlap verification:

As shown in FIG. 2a, To verify timing, Alice and Bob send qubits (μ˜1) and BSM are maximized. Verification of time overlap is done by mapping qubits from Alice and Bob using a given qubit sequence e.g. |el>, |le>, |++>, |ee>, |ll>, I−−>, |ee>, |+−>, |−+>, |ll>

### Timing Feedback Protocol

In an initial phase low repetition frequency of optical pulses is used for a coarse matching of the optical pulses at Charlie, i.e. the objective is to obtain pulse synchronization on the same clock cycle.

Charlie (131) may interrupt the trigger sequence in the above process to verify that the qubit signals sent by Alice and Bob that are triggered by a given master clock cycle event arrive at the interference device at the same time, i.e., to ensure that a given interference event corresponds to the correct qubit signal preparation events at Alice and Bob, independently.

In a second phase, for fine tuning of the timing synchronization, a high repetition rate of the optical pulses is used. At this point the detection event overlap maximization technique is used.

Once interference events correspond to the correct qubit signal preparation events at Alice and Bob, we do a search algorithm to maximize the overlap of the qubit signals within the clock cycle.

The receiver controller analyzes the timing of detections from the superconducting nanowire single photon detectors to evaluate the temporal overlap of pulses arriving from Alice and Bob. If pulses corresponding to the respective time-bins arrive slightly earlier or later from Bob compared to those from Alice, this discrepancy will manifest as temporal broadening of the detection events, provided that the FPGA and single photon detectors possess adequate temporal resolution.

A minimization algorithm is performed to reduce the temporal width of a plurality of detection events Δtq (as shown in FIG. 2a) that are being measured via FPGA, maximizing temporal indistinguishability between qubit signals sent by Alice and Bob individually.

In this mode, Charlie, the receiver, delays the clock signal sent to one or more of the transmitters (i.e., Alice and Bob) to optimize the detection event overlap.

In order to verify the timing, Bell State Measurements (BSMs) are performed:

Qubit signal overlap is performed by sending low mean photon number, μ˜1 in the early and late pattern, with a frequency of at least 1 MHz. BSM is performed to verify timing.

According to FIG. 2a, verification of time overlap is done by interfering qubit signals from Alice and Bob (101a, 101b) using a chosen qubit signal sequence

Single photon detector technology utilizes a superconducting circuit that detects photon absorption by registering a temporary increase in the circuit's temperature and subsequent electrical resistance. These detectors are sensitive to both visible and infrared wavelengths and offer advantages over other types of single-photon detectors, including enhanced timing resolution and recovery rates. Projection into a Bell state can be performed by the single photon detectors regardless of the time-bin states that Alice and Bob (101a, b) prepare.

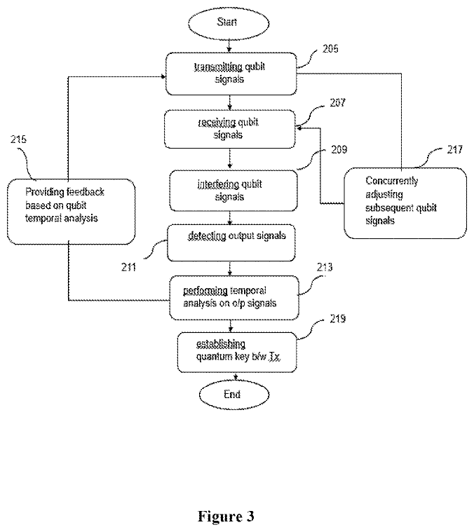

FIG. 3 represents a method of establishing at least a portion of a cryptographic key. In the first step, each transmitter transmits qubit signals (205) within specific time windows, characterized by bases and modes. Signals are temporally spaced and correspond to a basis and mode. After then, the receiver gathers (207) qubit signals from all transmitters. Qubit signals from multiple transmitters are interfered (209) to create an output signal. After, multiple received qubit signals are interfered to produce an output signal, detectors detect the resulting output signal (211) from interference. Further, the output signals are analyzed for temporal information on detected output signals (213), and automatically provide feedback (215) to transmitters based on qubit temporal information. Transmitters which transmit the qubit signal (205) receive feedback from the receiver based on temporal information (213) and transmitters transmitting qubit signals (205) concurrently adjust subsequent qubit signals based on received feedback (217). The qubit signals are adjusted based on received feedback (217), the part of cryptographic key or quantum key is established (219) by using transmitted information about detected output signals.

Although the present invention has been described and illustrated with respect to preferred embodiments and preferred uses thereof, it is not to be so limited since modifications and changes can be made therein which are within the full, intended scope of the invention as understood by those skilled in the art.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within scope of the appended claims.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between. The scope of the embodiments of the present invention is ascertained by the claims to be submitted at the time of filing the complete specification.

1. A quantum communication system comprising:
1) at least two transmitters; and
2) a receiver;
3) wherein each of the transmitters comprises:
i. a light source configured to transmit a series of temporally spaced apart qubit signals, each qubit signal being within a respective time window, and corresponding to a basis within a plurality of bases, and a mode within a plurality of modes of the basis; and
ii. a transmitter controller configured to control the series of qubit signals emitted by the light source; and
4) the receiver comprising:
i. an interference device having multiple inputs configured to receive the series of qubit signals from each of the transmitters, and multiple outputs configured to output an output signal based on an interference of the received qubit signals at the interference device; and
ii. a plurality of detectors configured to detect the output signal at the multiple outputs of the interference device; and
5) a receiver controller configured to:
i. transmit information concerning the detected output signals to the transmitters; and
ii. provide feedback including temporal information pertaining to a plurality of the detected output signals;
6) wherein the quantum communication system is configured concurrently to:
i. adjust one or more characteristics of subsequently transmitted qubit signals based on the provided feedback, wherein the characteristics based on temporal similarity of the qubit signals; and
ii. facilitate establishment of at least part of a cryptographic key between the transmitters based on the transmitted information concerning the detected output signals.

2. The quantum communication system according to claim 1, wherein the system is configured to make subsequent adjustments to the transmitted qubit signals based on the most recently received feedback, and further based on previous adjustments and associated feedback.

3. The quantum communication system according to claim 1, wherein each transmitter is configured to adjust the timing of the emitted qubit signals based on the temporal feedback by an amount, wherein the amount is determined from a deviation of the coincidence rate from a predetermined value.

4. The quantum communication system according to claim 1, wherein each light source comprises a laser, and each transmitter is configured to adjust the timing of the emitted qubit signals.

5. The quantum communication system according to claim 1, wherein the qubit signal exhibits a full-width half maximum of less than 500 ps.

6. The quantum communication system according to claim 1, wherein the qubit signals are conveyed from the transmitter to the receiver through a fiber optic cable.

7. The quantum communication system of claim 1, wherein at least one of the transmitter and receiver controllers incorporates a Field-Programmable Gate Array (FPGA).

8. The quantum communication system of claim 1, wherein feedback is provided on temporal characteristics of the qubit signals, and temporal analysis of the output signals is conducted over distinct respective time periods.

9. The quantum communication system of claim 1, wherein the establishment of the cryptographic key is based on information derived from detected output signals corresponding to Bell states or GHZ states.

10. The quantum communication system of claim 1, wherein the establishment of the cryptographic key is based on information derived from detected output signals corresponding to a photon detected in an early bin at a first detector and a photon detected in a late bin at a second detector.

11. The quantum communication system of claim 1, wherein each qubit signal among the transmitted qubit signals is encoded utilizing early and late time bins within the respective time window.

12. A quantum communication system receiver comprising:
1) an interference device with multiple inputs configured to receive multiple series of temporally spaced apart qubit signals from multiple transmitters, and multiple outputs configured to output an output signal based on the interference of the received qubit signals at the interference device;
2) multiple detectors configured to detect the output signal at multiple outputs of the interference device; and
a receiver controller configured to:
1) transmit information concerning the detected output signals to the transmitters; and
2) provide feedback based on the outputs, wherein the feedback is derived from temporal information determined through a temporal analysis of a plurality of the detected output signals and pertains to temporal similarity of the qubit signals.

13. A timing characterization method for synchronizing optical pulses emitted by each transmitter to the receiver controller, comprising:
1) sharing a 200 MHz clock from the receiver controller to a first transmitter controller via a communication channel (303);
2) sending a trigger from the receiver controller to the transmitter controller via a communication channel at time t₀;
3) receiving the trigger by the transmitter controller at time t₁ and sending high intensity pulses at a frequency between 1 KHz and 1 MHz via the communication channel at time t₂, returning the trigger by transmitter controller at time t₃;
4) detecting by the receiver controller an interference signal at time t₆ and returning the trigger from the transmitter controller at time t₄ adding by the receiver controller Δ_{BSM-HOM} to Δt₅ and calculating Cl₁ and Cl₂;
5) calculating by the receiver controller Δt₂=Δt₆−Δt₅−Δt₄ and deriving the arrival time of the optical pulse at the interference device, t₅;
6) repeating steps 2-5 for at least 1 second and stopping;
7) repeating the process for a second transmitter controller, initiating with a trigger sent from the receiver controller; and calculating the corresponding Δt₂ for the second transmitter controller and deriving t₅ for said transmitter controller; and
8) applying Δ offset by the receiver controller to the qubit signal emitted by of one of the transmitters such that t_{5A}=t_{5B}, where t_{5A} and t_{5B} corresponds to the arrival times of the qubit signals from each transmitter and their corresponding link to the receiver controller.

14. The method of claim 13, wherein the communication channel Ch_AC1 and Ch_BC2 are implemented using SFP transceivers.

15. A method of establishing at least a portion of a cryptographic key, the method comprising:
i. transmitting a controlled series of temporally spaced apart qubit signals from each of a plurality of transmitters, each qubit signal being within a respective time window, and corresponding to a basis within a plurality of bases, and a mode within a plurality of modes of the basis;
receiving the qubit signals at a receiver;
i. interfering multiple received qubit signals from the multiple transmitters to produce an output signal based on an interference of the received qubit signals at the interference device;
detecting the output signals; and
i. transmitting information relating to the detected output signals to the transmitters, automatically providing feedback based on temporal information determined from a temporal analysis of a plurality of the detected output signals, wherein the feedback corresponds to temporal characteristics of the qubit signals, the characteristics comprising: temporal similarity of the qubit signals;
ii. concurrently adjusting subsequently transmitted qubit signals based on the received feedback; and
iii. establishing at least part of a cryptographic key between the transmitters based on the transmitted information relating to the detected output signals.

16. A method as claimed in claim 13 wherein the interference device comprises a beam splitter or a Mach-Zehnder interferometer.

17. A method as claimed in claim 15, wherein the interference device comprises a beam splitter or a Mach-Zehnder interferometer.
